(19) United States
(12) Patent Application Publication
(10) Pub. No.: US 2013/0342851 A1
(43) Pub. Date: Dec. 26, 2013

(54) METHOD FOR GATHERING INFORMATION RELATING TO AT LEAST ONE OBJECT ARRANGED ON A PATIENT POSITIONING DEVICE IN A MEDICAL IMAGING DEVICE AND A MEDICAL IMAGING DEVICE FOR CARRYING OUT THE METHOD

(71) Applicants: Holger Dresel, Altendorf (DE); Matthias Drobnitzky, Spardorf (DE); Jens Gühring, Erlangen (DE); Edgar Müller, Heroldsbach (DE); Stefan Popescu, Erlangen (DE)

(72) Inventors: Holger Dresel, Altendorf (DE); Matthias Drobnitzky, Spardorf (DE); Jens Gühring, Erlangen (DE); Edgar Müller, Heroldsbach (DE); Stefan Popescu, Erlangen (DE)

(21) Appl. No.: 13/905,501

(22) Filed: May 30, 2013

(30) Foreign Application Priority Data
May 31, 2012 (DE) 102012209190.4

(51) Int. Cl. G01B 11/24

(52) U.S. Cl. CPC G01B 11/24
USPC 356/601

(57) ABSTRACT

A method for gathering information relating to at least one object positioned on a patient positioning device of a medical imaging device is provided. The method includes the following steps:
gathering by optical means of 3-D image data relating to the object positioned on the patient positioning device by means of a 3-D image data recording unit,
transferring the gathered 3-D image data from the 3-D image data recording unit to an evaluating unit,
determining information relating to the object positioned on the patient positioning device based on the 3-D image data by means of the evaluating unit,
generating output information based on the determined information relating to the object positioned on the patient positioning device, and
outputting the output information relating to the object positioned on the patient positioning device.

### CROSS REFERENCE TO RELATED APPLICATIONS

The present application claims priority to European Patent Office application No. 102012209190.4 DE filed May 31, 2012, the entire content of which is hereby incorporated herein by reference.

### FIELD OF INVENTION

The present invention relates to a method for gathering information relating to at least one object arranged on a patient positioning device in a medical imaging device. Firstly, 3-D image data relating to the object arranged on the patient positioning device are gathered optically by means of a 3-D image data recording unit and subsequently the gathered 3-D image data are transferred from the 3-D image data recording unit to an evaluating unit.

### BACKGROUND OF INVENTION

Investigations with the aid of medical imaging devices, for example, with a magnetic resonance device, a computed tomography device, a PET (Positron Emission Tomography) device, etc. are applied for different medical investigations. When medical diagnostic measurements are made, shorter examination times are always desirable, firstly for cost reasons and, secondly, in order to be able to prepare images of moving organs. This means, for example, that during patient preparation, the operating personnel carrying out the medical imaging examination must employ a high degree of concentration when positioning the patient in a correct position on the patient positioning device for the medical imaging examination and/or when positioning accessory units, such as local coils and/or an ECG accessory. False positioning can lead to unwanted overhanging of the wrongly positioned objects beyond the patient positioning device and thus, on movement of the patient positioning device, to damaging of the wrongly positioned objects, for example, to crushing of cables and/or injury to the patient, etc.

The patient should also move as little as possible throughout the duration of the magnetic resonance examination, since such movement can falsify the measurements.

### SUMMARY OF INVENTION

It is therefore an object of the present invention to provide a method and a device by means of which monitoring of the objects lying on the patient positioning device can be carried out in a rapid and time-saving manner. The object is achieved with the features of the independent claims Advantageous embodiments are disclosed in the subclaims.

The invention is based on a method for gathering information relating to at least one object positioned on a patient positioning device of a medical imaging device, comprising the following steps:

gathering by optical means of 3-D image data relating to the object positioned on the patient positioning device by means of a 3-D image data recording unit,

transferring the gathered 3-D image data from the 3-D image data recording unit to an evaluating unit,

determining information relating to the object positioned on the patient positioning device based on the 3-D image data by means of the evaluating unit,

generating output information based on the determined information relating to the object positioned on the patient positioning device, and

outputting the output information relating to the object positioned on the patient positioning device.

By this means, it is possible to carry out monitoring of objects positioned on the patient positioning device in a particularly rapid and time-saving manner, thereby advantageously increasing safety during the medical imaging examination, for example, examination by magnetic resonance imaging, computed tomography and/or another medical imaging examination which a person skilled in the art deems useful. Preferably, the sequence of the method according to the invention for gathering information relating to at least one object positioned on the patient positioning device of a medical imaging device enables, in particular, the preparation and/or positioning of the patient on the patient positioning device before the medical imaging examination to be monitored and for possible errors during the preparation and/or positioning of the patient on the patient positioning device to be detected in good time and thereby to prevent fault-laden medical imaging examinations. In addition, by means of the output information, clinical personnel supervising the medical imaging examination can be rapidly notified of a possible error source during the preparation and/or positioning of the patient on the patient positioning device, so that in this way, particularly time-saving preparation and/or positioning of the patient can be achieved. In addition, by this means, a stressful situation, in particular the medical imaging examination with the associated preparation of the patient, can be shortened, advantageously for the patient.

In this context, an object arranged on a patient positioning device should be understood, in particular, to be a human or animal patient or an accessory unit for the medical imaging examination, such as local coils for magnetic resonance examinations, an ECG unit, etc. Preferably, the 3-D image data recording unit comprises conventional 3-D scanners which have a large scanning region, in particular the whole of the patient positioning device, with an accuracy of a maximum of 10 mm, preferably a maximum of 5 mm and particularly preferably a maximum of 3 mm, so that a particularly cost-effective 3-D image data recording unit is available for the method. In addition, the output information can be different from the information determined concerning the object positioned on the patient positioning device.

The information determined relating to the object positioned on the patient positioning device can comprise position information and/or movement information and/or extent information and/or mass information and/or object type information. By means of the position information, for example, a current position of the patient and/or of accessory units, and thus possible erroneous positionings, can be determined. Using movement information, advantageously, a movement of the patient can be detected, in particular during the medical imaging examination and, thereby, possible measurement errors due to the movement can be detected early. In addition, by means of the movement information, for example, the breathing of the patient can also be detected in order to trigger the medical imaging device. Extent information can be used, in particular, to detect a maximum extent, for example, of the patient and/or of accessory units in relation to the patient positioning device, so that possible hindrances during movement of the patient positioning device, in particular a patient table of the patient positioning device, can be determined. In addition, by means of the extent information, conclusions can be drawn, for example, about a size of the patient, so that the information can also be used for monitoring patient registration. By means of the mass information, in particular, a weight of the patient can be derived. With object type information, in particular, a type of an accessory unit, for example, a coil type of a local coil, can be detected.

It is also proposed that the 3-D image data comprise at least two image recordings which have been recorded at different times, and the information relating to the object positioned on the patient positioning device is determined from said at least two image recordings. Advantageously, a temporal change in a position of the object positioned on the patient positioning device can be derived based on the two image recordings and thereby a movement of the object positioned on the patient positioning device, in particular a patient table of the patient positioning device can be derived. For example, by this means, a movement of the patient can be detected based on at least one difference image which essentially represents the differences in the position of the object positioned on the patient positioning device between the at least two images recorded at different times.

A position change and/or movement of the patient can be detected particularly rapidly and effectively if at least 15 images are recorded per second for optically gathering the 3-D image data. Preferably, however, at least 20 images per second are recorded and, particularly preferably, approximately 30 images per second by means of the 3-D image data recording unit.

In an advantageous embodiment of the invention, it is proposed that the information relating to the object positioned on the patient positioning device is determined based on the detection of body features of the object positioned on the patient positioning device by means of the 3-D image data. The body features can be, for example, a skeleton outline of the patient and/or an extremity of the patient and/or joint points, in particular joint axes of the patient and/or the face of the patient and/or a housing property of accessory units and/or design properties of accessory units, etc. By means of this embodiment of the invention, the objects positioned on the patient positioning device can advantageously be detected and recognized by the evaluating unit independently and/or automatically. In addition, patient registration or allocation of the patient to a medical imaging investigation by means of facial recognition by the evaluating unit for monitoring purposes is also conceivable. Furthermore, positioning of the objects positioned on the patient positioning device can be monitored with regard to faulty positioning. Unwanted objects which are used, for example, assistively for positioning the patient on the patient positioning device, but which are to be removed from the patient receiving region for the medical imaging examination, can advantageously be detected herewith. Furthermore, a patient can also be monitored herewith during the medical imaging examination with regard to unwanted movements of the patient. The body features can also be detected, for simpler recording, by means of additional markings, for example, by means of colored markings and/or infrared markings and/or retroreflective markings and/or QR-codes, etc. As an alternative hereto, the additional markings can also be detected with a conventional image recording, wherein the conventional image recording can also be made using a 2-D camera and/or a color camera and/or an infrared camera, etc. and is integrated into the 3-D image data recording unit which is configured for recording 2-D image data and/or color image data and/or infrared image data.

It is also proposed that the information relating to the object positioned on the patient positioning device is determined from the 3-D image data, based on detection of the patient positioning device and on size information associated with the patient positioning device. Advantageously, based on the size information which is associated with the patient positioning device, in particular a patient table of the patient positioning device, size information and/or position information relating to the object positioned on the patient positioning device can thereby be determined by the evaluating unit both particularly rapidly and independently and/or automatically. Furthermore, based on 3-D image data and by means of the size information associated with the patient positioning device, in particular the patient table, a mass distribution can also be determined for the object arranged on the patient positioning device and thus, for example, a weight of the patient can be determined by means of the evaluating unit.

In a further embodiment of the invention, it is proposed that, in order to generate the output information, the determined information relating to the object positioned on the patient positioning device is compared with a safety value. Every change and/or positioning of the object positioned on the patient positioning device which goes beyond the safety value is detected by the evaluating unit, so that rapid determination of a faulty positioning of the object positioned on the patient positioning device can be carried out. The faulty positioning can include, for example, faulty patient positioning, in particular a ring-shaped arrangement of extremities of the patient and/or overhanging extremities of the patient, for example, an arm of the patient hanging down from the patient positioning device and/or faulty positioning of the patient, and/or faulty positioning of accessory units, in particular an accessory unit not required for the medical imaging device and/or an accessory unit which is not connected and/or plugged in and/or an accessory unit which overhangs the patient positioning device, in particular the patient table of the patient positioning device. Preferably, the safety value comprises a maximum permissible value and/or range for the recorded information relating to the object positioned on the patient positioning device, so that if the safety value is complied with, safe performance of the medical imaging examination can always be assured. In addition, the safety value can also comprise the response “Yes” for a decision that can only be answered with “Yes” or “No”. This can be advantageous particularly in the event of faulty positioning of the patient, in particular, a ring-shaped and/or closed arrangement of extremities of the patient and/or other faulty positioning of the patient. For example, this could be an enquiry concerning the non-presence of extremities of the patient arranged in a ring form.

Advantageously, the safety value comprises a position enquiry and/or a movement enquiry, such that advantageously a current sitting and/or position of the object positioned on the patient positioning device can be compared with an ideal and/or correct position of the object positioned on the patient positioning device and deviations which are greater than the safety value can be recognized particularly rapidly. In this way, a high safety standard can be achieved for the medical imaging examination. Alternatively or additionally, the safety value can also comprise a maximum permissible location volume for the object positioned on the patient positioning device, so that, by means of the safety value, particularly rapid detection of partial regions of the object overhanging a patient table of the patient positioning device can be carried out, this being particularly advantageous on displacement of the patient table into a receiving region and/or examination region of the medical imaging device. In this way, for example, overhanging cables of accessory units, in particular of ECG units and/or of local coils for a magnetic resonance examination and/or overhanging local coils can advantageously be detected.

In a further embodiment of the invention, it is proposed that, in the event that the safety value is exceeded, the output information comprises a warning message, by means of which a person supervising the medical imaging examination can be notified particularly rapidly of the exceeding of a safety value and the existence of a hazard. The warning message can comprise, for example, an optical and/or an acoustic warning, wherein output of the output information, in particular the warning message, can be carried out by means of acoustic or visual output means. The acoustic and/or visual output means can be arranged directly at the patient positioning device and/or a detector unit of the medical imaging device and/or can be incorporated in a control unit of the medical imaging device, wherein the control unit is usually arranged outside an examination room in which the detector unit is situated. In this way, for example, a warning message can be given to the operating personnel supervising the medical imaging examination as early as during positioning of the patient and/or of accessory units on the patient positioning device. Equally, the output of a warning message can be issued during the medical imaging examination as, for example, when a patient moves during the imaging examination, so that the operating personnel situated in a control room for monitoring the medical imaging examination can decide whether the medical imaging examination should be broken off and started again.

Alternatively or additionally, the warning message can comprise the deactivation of functions of the patient positioning device and/or of the medical imaging device, so that, in the event that the safety value is exceeded, the warning message can consist, inter alia, of blocking and/or deactivation of functions of the patient positioning device and/or of the medical imaging device. For example, in the event that a cable overhangs the patient positioning device, a function of the displacement of the patient positioning device can be blocked, so that due to the non-operation of this function, the operating personnel can be notified of, for example, a false position.

In an advantageous development of the invention, it is proposed that information relating to operating personnel is recorded based on the 3-D image data. For this purpose, a scan range of the 3-D image data recording unit is dimensioned such that the operating personnel is included by the scanning range of the 3-D image data recording unit, in particular during positioning and/or preparation of an object on the patient positioning device. With this embodiment of the invention, a communication of the operating personnel with, for example, a control unit of the medical imaging device and/or of the evaluating unit can advantageously be achieved.

Particularly advantageously, by means of the information relating to the operating personnel and/or relating to the object positioned on the patient positioning device, at least partial control of a movement of the patient positioning device and/or at least partial control of the medical imaging device is accomplished, so that a quicker and more effective measuring procedure can be achieved. For example, in this way, positioning of the patient positioning device can be controlled in that gestures of the operating personnel are recognized in the 3-D image data by the evaluating unit and said gestures are assigned a control function, for control, for example, of the patient positioning device. The control functions can be made up from raising a patient table of the patient positioning device, lowering of the patient table, displacement of the patient table into or out of a receiving region. In addition, by this means, it is possible to take account, particularly rapidly, of wishes of the patient during the medical imaging examination if, for example, a gesture of the patient recorded in the 3-D image data is recognized by the evaluating unit during the medical imaging examination as a control gesture and said control gesture is assigned to a control signal. For example, lifting a hand by the patient during the medical imaging examination can be assigned to an interruption of the medical imaging examination or to switching on a microphone, or the like.

It is also proposed that at least one further item of information relating to the object positioned on the patient positioning device is detected by means of at least one marking element arranged at the object. The marking element can be, for example, a colored marking element and/or an infrared marking element and/or a retro-reflective marking element and/or a QR code. In this way, additional information, particularly position information relating to the object positioned on the patient positioning device can advantageously be detected by means of the 3-D image data recording unit, for example, by means of a 2-D camera and/or a color camera and/or an infrared camera, etc., of the 3-D image data recording unit, which is configured for detecting 2-D image data and/or color image data and/or infrared image data.

Furthermore, the invention relates to a medical imaging device, in particular a magnetic resonance device with a detector unit, a patient positioning device on which a patient is positioned for a medical imaging examination, a receiving region surrounded by the detector unit for receiving the patient positioned on the patient positioning device for the medical imaging examination, and a 3-D image data recording unit for gathering information relating to the patient positioned on the patient positioning device, wherein the 3-D image data recording unit is configured for performing the method according to claims 1 to 12. Particularly time-saving, rapid monitoring of the object positioned on the patient positioning device can be carried out and, consequently, safety can advantageously be enhanced during the medical imaging examination, which is for example a magnetic resonance examination, a computed tomography examination and/or another medical imaging examination which a person skilled in the art deems useful. In addition, particularly the preparation and/or positioning of the patient on the patient positioning device, which takes place chronologically before the medical imaging examination, can be monitored and possible errors during preparation and/or positioning of the patient on the patient positioning device can be detected in good time and thus a fault-laden medical imaging examination can be prevented. Furthermore, clinical personnel supervising the medical imaging examination can be notified rapidly, by means of the output information, of a possible error source during preparation and/or positioning of the patient on the patient positioning device, so that preparation and/or positioning of the patient can be achieved in a particularly time-saving manner

Preferably, the 3-D image data recording unit is arranged at least partially outside the receiving region, with the result that an advantageous viewing angle and/or recording region over the patient and the patient positioning device, can be achieved for the 3-D image data recording unit in particular for positioning and/or preparation of the patient on the patient positioning device, in particular a patient table of the patient positioning device. Alternatively or additionally, the 3-D image data recording unit can also be arranged at least partially within the receiving region, so that a movement of the patient during the medical imaging examination can be detected. Additionally, a trigger signal, for example, a breathing movement, in particular, can be detected for the medical imaging examination by means of the at least one 3-D image data recording unit which is arranged at least partially within the receiving region.

### BRIEF DESCRIPTION OF THE DRAWINGS

Further advantages, features and details of the invention are disclosed in the following description of exemplary embodiments illustrated in the drawings, in which:

FIG. 1 is an inventive method for gathering information relating to at least one object arranged on a patient positioning device and

FIG. 2 is an inventive medical imaging device in a schematic representation.

### DETAILED DESCRIPTION OF INVENTION

FIG. 2 shows a schematic representation of an inventive medical imaging device 100 which, in the present exemplary embodiment, consists of a magnetic resonance device. Alternatively, the medical imaging device 100 can also consist of a computed tomography device, a PET device and/or another medical imaging device 100 which a person skilled in the art deems useful.

The magnetic resonance device comprises a detector unit 101 consisting of a magnet unit, which comprises a main magnet 102 for generating a strong and, in particular, constant main magnetic field 103. The magnetic resonance device also comprises a cylindrical receiving region 104 for receiving a patient 105, wherein the receiving region 105 is surrounded in a peripheral direction by the magnet unit. The patient 105 can be advanced by means of a patient positioning device 106 of the magnetic resonance device into the receiving region. For this purpose, the patient positioning device 106 is movable within the magnetic resonance device.

The magnetic unit also has a gradient coil unit 107 for generating the magnetic field gradients that are used for position encoding during imaging. Furthermore, the magnetic unit comprises a high frequency antenna unit for the excitation of polarization, which forms in the main magnetic field 103 generated by the main magnet 102.

In order to control the main magnet 102, the gradient coil unit 107 and the high frequency antenna unit 108, the magnetic resonance device has a control unit 109 centrally consisting of a computer unit 109. The control unit 109 controls the magnetic resonance device, such as for example, the execution of a pre-determined imaging gradient echo sequence, centrally. Control information such as, for example, imaging parameters as well as reconstructed magnetic resonance images can be displayed for operating personnel on a display unit 110, for example, at least one monitor, of the magnetic resonance device. In addition, a further display unit is also arranged at a housing (not shown in detail) of the magnet unit. In addition, the magnetic resonance device has an input unit 111, by means of which information and/or parameters can be input by the operating personnel during a measuring procedure.

Furthermore, the magnetic resonance device has a 3-D image data recording unit 113 for recording information relating to the patient 105 positioned on a patient table 114 of the patient positioning device 106. The 3-D image data recording unit 113 comprises at least one first 3-D image recording element 115 which is arranged outside the receiving region 104 in order to record the patient 105. However, the at least one first 3-D image data recording element 115 is arranged within a magnetic resonance room 116, wherein the detector unit 101 of the magnetic resonance device is also arranged. The control unit 109, however, is positioned outside the magnetic resonance room 116 in a control room 117, from where the medical imaging examination, in particular the magnetic resonance examination is supervised.

The 3-D image data recording unit 113 also has at least one further 3-D image data recording unit 118 which is arranged within the receiving region 104, the further 3-D image data recording unit 118 being arranged within the receiving region 104 in such a way that the patient 105 and, in particular, movements of the patient 105 during the magnetic resonance examination can be detected. Alternatively, the at least one further 3-D image data recording element 118 can be arranged at an edge region of an aperture of the receiving region 104.

The two 3-D image data recording elements 116, 118 each have a scanning region 119, 120 which covers, in particular, the patient positioning device 106 and a region arranged around the patient positioning device 106, the scanning region 119, 120 having an extent in the region of the patient positioning device 106 of at least 2 m, preferably of at least 3 m and particularly preferably, at least 4 m. The scanning region 119 of the first 3-D image data recording element 116 essentially covers a region in which the patient positioning device 106 is arranged during positioning and/or preparation of the patient 105 on the patient table 114. The scanning region 120 of the further 3-D image data recording element 118, however, covers a region within the receiving region 104, in which the patient positioning device 106 is arranged during a magnetic resonance examination. An optical resolution of the 3-D image data recording element 116, 118 is a maximum of 10 mm, preferably a maximum of 5 mm and particularly preferably a maximum of 3 mm

Furthermore, the 3-D image data recording unit 113 has an evaluating unit 121 which is connected via a data line to the 3-D image data recording elements 116, 118 for data exchange. The evaluating unit 121 has a processor and evaluating programs for evaluating 3-D image data. In the present exemplary embodiment, the evaluating unit 121 is configured as separate from the control unit 109 and is arranged within the control room 117. Alternatively, the evaluating unit 121 can also be integrated within the control unit 109. In addition, the evaluating unit 121 is connected via the data line to the display units 111, 112 of the control unit 121 and the detection unit 101, so that output information generated by the evaluating unit 121 can be visibly displayed for operating personnel 122. The evaluating unit 121 is also connected to the control unit 109 by means of the data line for an exchange of control commands, which are passed on by the control unit 109 to the detection unit 101 and/or the patient positioning device 106.

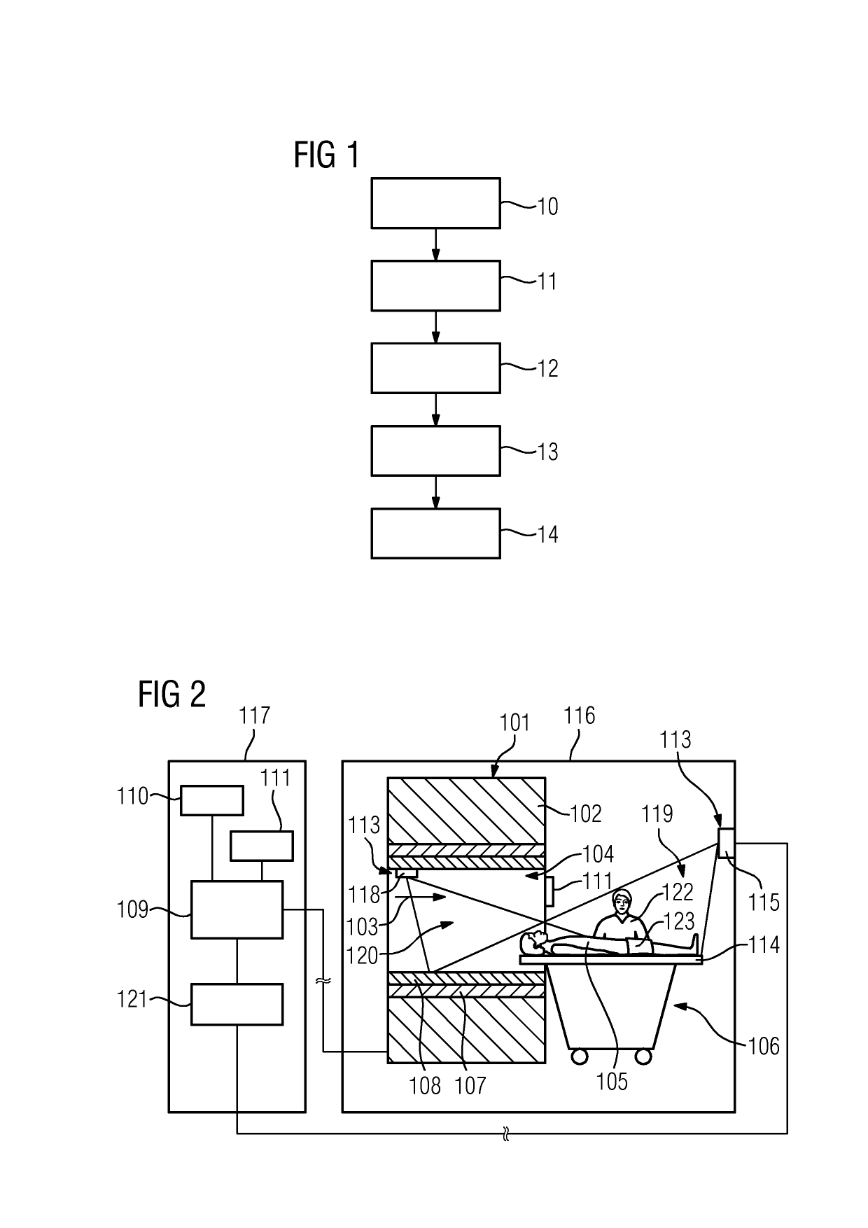

FIG. 1 shows an inventive method for gathering information relating to at least one object arranged on the patient positioning device 106. The method serves for monitoring positioning and/or preparation of the patient 105 on the patient positioning device 106 chronologically before the magnetic resonance examination, the emphasis in this instance being on the detection of position variables and/or position information and the detection of incorrect positioning. In addition, the method also involves monitoring the patient 105 during the magnetic resonance examination, wherein here in particular, movements of the patient 105 are to be detected.

In a first method step 10, the gathering of 3-D image data relating to the patient positioning device 106 and the objects positioned on the patient positioning device 106. Apart from the patient 105, the objects also comprise accessory units 123, for example, local coils required for the magnetic resonance examination to be undertaken and/or an ECG unit and/or further units required for the magnetic resonance examination to be undertaken. Furthermore, in said first method step 10, a position and/or gestures of the operating personnel 122 are detected if the operating personnel 122 are situated within the scanning region 119, 120 of the 3-D image data recording elements 116, 118.

Throughout the duration of the positioning and/or preparation of the patient 105 on the patient table 114 of the patient positioning device 106, involving the positioning of the patient 105 in an examination position, for example, in an abdominal position, a dorsal position, etc. and the placement or attachment of the accessory units 123, in particular local coils and/or an ECG unit, etc., the recording of 3-D images by means of the 3-D image data recording elements 116, 118 takes place. The two 3-D image data recording elements 116, 118 record, in the first method step 10, the 3-D images at a rate of at least 15 images per second, preferably at least 20 images per second and particularly preferably approximately 30 images per second.

The positioning and/or preparation of the patient 105 on the patient table 114 of the patient positioning device 106 is supervised by the operating personnel 122. In addition, during the positioning and/or preparation of the patient 105 on the patient table 114, marking of the patient 105 can be carried out in that individual body regions, in particular joint regions of the patient, are provided with marking elements which are visible in the recorded 3-D image data. The marking elements can comprise QR codes and/or colored marking elements and/or infrared marking elements and/or retro-reflective marking elements, or the like. Furthermore, by means of the detection of the marking elements, additional information, in particular positional information concerning the object arranged on the patient positioning device can advantageously be recorded by means of a further recording unit of the 3-D image data recording unit, for example, by means of a 2-D camera and/or a color camera and/or an infrared camera, etc. of the 3-D image data recording unit, which is configured for gathering 2-D image data and/or color image data and/or infrared image data.

In a subsequent method step 11, transfer of the 3-D image data from the 3-D image data recording elements 116, 118 to the evaluating unit 121 is carried out, wherein the 3-D image data are transferred to the evaluating unit 121 immediately following recording. A further method step 12 of determining information concerning the objects positioned on the patient positioning device 106 is now performed by the evaluating unit 121 in a further method step 12, based on the recorded and transferred 3-D image data. The information determined by the evaluating unit 121 concerning the objects positioned on the patient positioning device 106 in this method step can comprise position information and/or movement information and/or extent information and/or mass information and/or investigation type information, etc. For this purpose, different program units 121 which determine the different items of information based on the 3-D image data run within the evaluating unit 121.

In this method step 12, therefore, from the 3-D image data of different image recordings which image the same spatial region, but which have been recorded at different measuring times, movement information concerning the patient 105 and/or the operating personnel 122, in particular, is determined. By means of difference formation, the differences, in particular with regard to a position and/or a siting and/or an orientation of the patient 105 and/or of the operating personnel 122, between the individual image recordings is determined and therefrom, a movement of the patient 105 and/or of the operating personnel 122 is deduced.

Furthermore, in this method step 12, based on image recordings of the 3-D image data, body features of the objects positioned on the patient positioning device 106 and/or of the operating personnel 122 are detected and/or determined and, based on the detected body features, the information concerning the object positioned on the patient positioning device 106 and/or concerning the operating personnel 122 is determined. The body features can be, for example, a skeletal outline of the patient 105 and/or of the operating personnel 122 and/or extremities and/or joint points or joint axes and/or the face of the patient 105 and/or of the operating personnel 122. In addition, individual body regions of the patient 105, for example, joint regions can also be provided with the marking elements. By this means, a position and/or an orientation of the patient 105 on the patient positioning device 106 can be detected, for example, an abdominal position or a dorsal position of the patient 105 and/or a position in which the patient 105 is advanced feet first into the receiving region 104 by means of the patient positioning device 106 or a position, in which the patient 105 is advanced with the head foremost into the receiving region 104. Furthermore, detection of positional information relating to the patient 105, in particular individual body parts, for example, extremities and the positioning thereof relative to one another is possible such that a closed or ring-shaped arrangement of the extremities of the patient 105 can be detected. Here also, by detecting the marking elements, additional information and, in particular, position information concerning the object positioned on the patient positioning device can advantageously be gathered by means of a further recording unit of the 3-D image data recording unit, for example, by means of a 2-D camera and/or a color camera and/or an infrared camera, etc., of the 3-D image data recording unit configured for recording 2-D image data and/or color image data and/or infrared image data. Alternatively, the marking elements can also be detected by evaluation of the 3-D image data.

Aside from the position information, in this way, extent information and/or size information relating to the object can also be determined within the evaluating unit 121, based on the 3-D image data, so that body parts and/or accessory units 123 overhanging beyond the patient positioning device 106 can be detected. Herein, the object recorded in the 3-D image data is initially separated from the background by the evaluating unit 121, so that an object-specific investigation is possible and object-related information can be more easily determined from the 3-D image data. In addition, by this means, a maximum extent of an object surface in the 3-D image data can be determined. For this purpose, detection of the head and/or the face and of the feet of the patient 105 can be included and, therefrom, the size and/or an item of size information relating to the patient 105 can be determined by the evaluating unit 121. In addition, for determining the size information relating to the patient 105, and for determining the position information and/or orientation information relating to the patient 105, registration data and/or registration information generated by the evaluating unit 121 with the aid of a model and/or with learning methods can also be used. The learning methods can be used profitably, in particular, for face recognition and/or for recognizing body features of the patient 105.

Through the detection of extent information, a mass distribution of the patient 105 can also be calculated, for example, by means of a torque calculation and therefrom, weight information relating to the patient 105 can be derived. Alternatively, for this purpose, based on the extent information, an estimation regarding a volume of the patient 105 can be carried out by the evaluating unit 121, and thus also weight information relating to the patient 105 can be obtained. Furthermore, the detection of body features of the patient 105 and/or of the operating personnel 122 can also be used for determining movement information in that the detection of body features is incorporated into the difference formation.

Furthermore, the body features can also comprise a housing property and/or design properties of accessory items 123. In this way, object type information and/or function information can be recorded such as, for example, which local coil is being applied to the patient 105 for the magnetic resonance examination to be performed and whether the local coil in question is connected to the patient positioning device 106. In addition, position information and/or siting information and/or an orientation of the accessory units 123 can be recorded.

Furthermore, in this method step 12 information relating to the patient 105 positioned on the patient positioning device 106 can be determined from the 3-D image data, based on detection of the patient positioning device 106 and of size information associated with the patient positioning device 106. Using the reference size of the patient positioning device 106, size information relating to the patient 105 can be derived. However, for this purpose, it is necessary that a maximum extent of the patient 105 can be determined in the 3-D image data in that, for example, a face-recognition and/or a head-recognition program and a program for recognizing extremities is used by the evaluating unit 121. Furthermore, a precise position of the patient 105 and/or of accessory units 123 on the patient positioning device 106 can be determined, such as is favorable for the magnetic resonance examination to be carried out.

Additionally, in method step 12, detection and/or registration of the patient 105 is possible in that a program for face recognition runs within the evaluating unit 121. A patient 105 detected in this way can be compared by the evaluating unit 121 with the patient information also stored in the measurement parameters.

Following on from the method step 12 for determining the information relating to the objects positioned on the patient positioning device 106 is a further method step 13 for generating output information. The output information is generated by the evaluating unit 121, based on the information relating to the objects positioned on the patient positioning device 106. In this method step 13, the information determined relating to the objects positioned on the patient positioning device 106 is compared with a safety value. The safety value comprises a maximum permissible value for the gathered information relating to the objects positioned on the patient positioning device 106.

The safety value comprises a position enquiry and a movement enquiry. Thus, for example, by means of the difference formation from different 3-D image recordings, a movement of the patient 105 can be determined. By means of the movement enquiry, it is also determined whether the movement is disruptive for the magnetic resonance examination. Thus, for example, for a head examination, a foot movement by the patient 105 could be classified as non-critical for the magnetic resonance examination. The output information generated by the evaluating unit 121 comprises information on the movement, and information concerning whether said information could be critical or disruptive for the magnetic resonance examination.

Furthermore, by means of the movement enquiry, a movement of the patient 105 can be categorized such that said movement can be detected as a communication signal by the patient 105 during the magnetic resonance examination, such as for example, raising a hand and/or an arm, by which the patient 105 wishes to signal a problem and/or a measurement interruption and/or a communication via an acoustic microphone. Furthermore, by means of the movement enquiry, a gesture by the operating personnel 122 during positioning and/or preparation of the patient 105 on the patient positioning device 106 can be recognized as a control gesture and assigned to a control command. The output information generated by the evaluating unit 121 consequently comprises the control command

Using the position enquiry, as early as during the positioning and/or preparation of the patient 105 on the patient positioning device 106, the detected position and siting of the patient 105 is compared with an ideal position for the magnetic resonance examination being undertaken. Provided the current position and siting and/or orientation of the patient 105 is within a tolerance range, corresponding output information is generated which signals to the operating personnel 122 the correct position and siting and/or orientation of the patient 105. If the current position and siting and/or orientation of the patient 105 exceeds the tolerance range, corresponding output information is generated which signals to the operating personnel 122 the faulty position and/or orientation of the patient 105.

In addition, a position enquiry regarding the accessory units 123 can be carried out, for example, whether the accessory units 123 required for the magnetic resonance examination being undertaken are arranged at the correct position or within the tolerance range for the correct position. Unwanted accessory units 123 can also be identified in this way. The output signal thus contains information which signals to the operating personnel whether all the accessory units 123 are arranged in a correct position or whether false positioning of at least one accessory unit 123 has occurred. False positioning can relate, for example, to a position and/or a siting and/or an orientation of an accessory unit 123. Furthermore, the false positioning can also comprise a type of the accessory unit and/or a correct connection and/or a correct cabling of the accessory unit 123. A position of the connecting cable for the accessory unit 123 is also included herein, such that a cable of the accessory units 123 and/or lines of the accessory units 123 and/or plugs of the accessory units 123 which project beyond the patient table 114 are detected as false positionings of the accessory units 123.

Insofar as the evaluating unit has detected a false siting and/or position of an object positioned on the patient positioning device 106 and/or an undesirable movement of the patient 105, during the generation of the output signal, the output signal generated by the evaluating unit 121 comprises a warning notification for the operating personnel 122.

In a further method step 14, output of the output information is carried out. The output information is presented by the display units 110, the control unit 121 as said unit is, particularly during the magnetic resonance examination, and the operating personnel 122 monitors the magnetic resonance examination by means of the control unit 121. Furthermore, the outputting of the output information can also be carried out via the display unit 111 of the detector unit 101, so that, during positioning and/or preparation of the patient 105 on the patient positioning device 106, the operating personnel 122 is notified immediately of a possible false positioning of objects and/or the correct positioning of objects is confirmed to the operating personnel 122 by means of the output information.

Furthermore, the output information can also comprise a deactivation of a function of the patient positioning device 106 and/or of the magnetic resonance device. If, for example, a false positioning has been determined by the evaluating unit 121, the output information can comprise a deactivation of a function of a movement of the patient positioning device 106, in particular a movement of the patient table 114. In this way, the false positioning is notified to the operating personnel 122, so that, for example, crushing of overhanging cables and/or prolonged measuring periods can advantageously be prevented.

Provided the output information comprises a control command, in method step 15, said command is transferred from the evaluating unit 121 to the control unit 109, which executes the control command. The control command can comprise control of a positioning and/or a movement of the patient positioning device 106, for example, raising of the patient table 114 of the patient positioning device 106, lowering of the patient table 114, movement of the patient table 114 into or out of a receiving region 104.

Furthermore, the output information can also comprise a control command derived from a gesture by the patient 105. This control command is also transmitted by the evaluating unit 121 to the control unit 109 and executed, for example the switching on of a microphone for a communication by the patient 105 with the operating personnel 122. In addition, the control command can contain a trigger signal for the magnetic resonance examination, as determined, for example, by means of the detection of a breathing movement. This control command is also transmitted from the evaluating unit 121 to the control unit 109.

We claim:

1. A method for gathering information relating to an object arranged on a patient positioning device of a medical imaging device, comprising:
gathering by optical means of 3-D image data relating to the object positioned on the patient positioning device by means of a 3-D image data recording unit;
transferring the gathered 3-D image data from the 3-D image data recording unit to an evaluating unit;
determining information relating to the object positioned on the patient positioning device based on the 3-D image data by means of the evaluating unit;
generating output information based on the determined information relating to the object positioned on the patient positioning device; and
outputting the output information relating to the object positioned on the patient positioning device.

2. The method as claimed in claim 1, wherein the information determined relating to the object positioned on the patient positioning device is selected from the group consisting of: position information, movement information, extent information, mass information, and object type information.

3. The method as claimed in claim 1, wherein the 3-D image data comprise at least two image recordings which have been recorded at different times, and the information relating to the object positioned on the patient positioning device is determined from the at least two image recordings.

4. The method as claimed in claim 1, wherein at least 15 images are recorded per second for optically gathering the 3-D image data.

5. The method as claimed in claim 1, wherein the information relating to the object positioned on the patient positioning device is determined based on the detection of body features of the object positioned on the patient positioning device by means of the 3-D image data.

6. The method as claimed in claim 1, wherein the information relating to the object positioned on the patient positioning device is determined from the 3-D image data, based on detection of the patient positioning device and on size information associated with the patient positioning device.

7. The method as claimed in claim 1, wherein in order to generate the output information, the determined information relating to the object positioned on the patient positioning device is compared with a safety value.

8. The method as claimed in claim 7, wherein the safety value comprises a position enquiry and/or a movement enquiry.

9. The method as claimed in claim 7, wherein, in the event that the safety value is exceeded, the output information comprises a warning message.

10. The method as claimed in claim 9, wherein the warning message comprises deactivation of functions of the patient positioning device and/or of the medical imaging device.

11. The method as claimed in claim 1, wherein information relating to operating personnel is recorded based on the 3-D image data.

12. The method as claimed in claim 10, wherein, by means of the information relating to the operating personnel and/or relating to the object positioned on the patient positioning device, at least partial control of a movement of the patient positioning device and/or at least partial control of the medical imaging device is accomplished.

13. The method as claimed in claim 1, wherein a further item of information relating to the object positioned on the patient positioning device is detected by means of a marking element arranged at the object.

14. A medical imaging device, comprising:
a detector unit;
a patient positioning device on which the patient is positioned for the medical imaging examination;
a receiving region surrounded by the detector unit for receiving the patient positioned on the patient positioning device for the medical imaging examination; and
a 3-D image data recording unit for gathering information relating to the patient positioned on the patient positioning device,
wherein the 3-D image data recording unit is configured for performing the method according to claim 1.

15. The medical imaging device as claimed in claim 14, wherein the 3-D image data recording unit is arranged at least partially outside the receiving region.

16. The medical imaging device as claimed in claim 14, wherein the 3-D image data recording unit is arranged at least partially within the receiving region.
